(19) United States
(12) Patent Application Publication
(10) Pub. No.: US 2014/0376732 A1
(43) Pub. Date: Dec. 25, 2014

(54) DEVICE ECHO CANCELLATION

(71) Applicants: Lloyd Trammell, Thousand Oaks, CA (US); Greg Halpern, La Jolla, CA (US)

(72) Inventors: Lloyd Trammell, Thousand Oaks, CA (US); Greg Halpern, La Jolla, CA (US)

(73) Assignee: Max Sound Corporation, La Jolla, CA (US)

(21) Appl. No.: 14/184,623

(22) Filed: Feb. 19, 2014

Related U.S. Application Data
(60) Provisional application No. 61/766,532, filed on Feb. 19, 2013.

(51) Int. Cl. H04R 3/02

(52) U.S. Cl. CPC H04R 3/02; H04R 2430/20
USPC 381/71.2

(57) ABSTRACT

A Device Echo Cancellation system and process are disclosed. According to one embodiment, the present invention comprises an input audio source that is converted to a digital signal via a PCM convertor where the amplitude of the input audio source is sampled at regular intervals and translated into digital PCM audio. The resulting PCM audio is analyzed for its dynamic and harmonic content. Corrective sound waves are then generated that reduce the repetition of the original audio (echoes). The corrective sound waves are applied to the repeating audio echoes to create corrected sound waves. The corrected audio is then outputted from the system. The analyzing step of the Device Echo Cancellation process of the present invention comprises performing an evaluation of the PCM audio for dynamic and harmonic content; identifying repetitive harmonic content (echoes) of the PCM audio; determining a scale based on the ratio of the amplitude of the first repeat harmonic to the amplitude of the input PCM audio; generating sound waves with descending amplitude levels according to the determined scale; and phase shifting the newly generated sound waves to generate corrective sound waves. The phase shift of the inventive Device Echo Cancellation process is 90 to 180 degrees.

### CROSS-REFERENCE TO RELATED PATENT APPLICATIONS

Embodiments of the present invention relate to U.S. Provisional Application Ser. No. 61/766,532, filed Feb. 19, 2013, entitled “DEVICE ECHO CANCELLATION”, the contents of which are incorporated by reference herein and which is a basis for a claim of priority.

### BACKGROUND OF THE INVENTION

Voice communications typically include repetitive harmonics, conventionally referred to as echoes, which prevent a listener from experiencing the best sound from the source. An example of an echo is when either or both people on a phone can hear their own voice echoed back to them. A frequent cause of echo is voice signals that are too loud, causing these signals to transmit back to the sender.

The term echo cancellation is conventionally used to describe the process of removing echoes from a voice communication in order to improve voice quality. In addition to improving quality, echo cancellation has been used to increases capacity by preventing echoes from traveling across a network. Currently the common way to lessen these echoes in communication devices is the use of multiple microphones on the device (cell phone, tablet, computer, etc.). These microphones “listen” to the output of the device and use phase reversal to cancel out ant echoes it recognizes. This method can still leave echoes that the device can't remove or lessen effectively. This type of problem can be especially annoying on conference type calls with multiple devices involved.

Conventional echo cancellation techniques involve recognizing the echoes in the transmitted or received signal. Once the echo is recognized, it can be removed by ‘subtracting’ it from the transmitted or received signal. This technique is implemented using a digital signal processor (DSP) or software. The conventional techniques calculate an estimate of the echo from the original input signal. This technique requires adaptive signal processing to generate a signal accurate enough to effectively cancel the echo, where the echo can differ from the original due to various kinds of degradation along the way.¹

By requiring an estimate of the echo, the conventional techniques suffer from inherent uncertainties and inaccuracies created by the “guessing game.” What is required is an echo cancellation technique that is not reliant on guessing or estimating the echo signal, but instead is based on a dynamic, determinative process that is based on determination of the echo.

### SUMMARY OF THE INVENTION

The inventive Device Echo Cancellation (D.E.C.) process operates to reduce and eliminate repeat sound signals (echoes) in sound originating from various sources such as a microphone, phone, CD, movies, and the like. The inventive DEC process is based on dynamic and self adjusting properties that will allow for the lessening of harmonic content in any repetitive harmonics that may be present without resorting to guessing and estimating of the echo sound.

According to one embodiment, the inventive Device Echo Cancellation process comprises an input audio source. The input audio source is converted to a digital signal via a PCM convertor where the amplitude of the input audio source is sampled at regular intervals and translated into digital PCM audio. The resulting PCM audio is analyzed for its dynamic and harmonic content. Corrective sound waves are then generated that reduce the repetition of the original audio (echoes). The corrective sound waves are applied to the repeating audio echoes to create corrected sound waves. The corrected audio is then outputted from the system.

The analyzing step of the Device Echo Cancellation process of the present invention comprises performing an evaluation of the PCM audio for dynamic and harmonic content; identifying repetitive harmonic content (echoes) of the PCM audio; determining a scale based on the ratio of the amplitude of the first repeat harmonic to the amplitude of the input PCM audio; generating sound waves with descending amplitude levels according to the determined scale; and phase shifting the newly generated sound waves to generate corrective sound waves.

The D.E.C. module thus analyzes not only the input audio, but the repeats of the same audio in amplitude. Upon detecting the first echo, it measures the amplitude. After the second echo, it can predict the rest of the amplitude series until the echo disappears. In the event the third echo doesn't follow the prediction, the D.E.C. will continue to predict the amplitude and will keep lowering the amplitude of the successive echoes until they are gone. The echo replicated audio will be reversed in phase from 90 to 180 degrees. The highest amplitude will be shifted the most and as the amplitude lessens, so does the amount of phase shift until it reaches 90 degrees. The amount of phase shift is proportional to the amount of amplitude reduction of the echoes in the audio. This is done so that there will be much less effect on the audio, which is not echoes, that you are listening to on a device.

Preferably, the inventive DEC is a software DSP process that will be implemented into any communications device that has problems with echoes.

### BRIEF DESCRIPTION OF THE DRAWINGS

FIG. 1 is a flow chart showing the various steps of an exemplary embodiment of the Device Echo Cancellation Module according to the present invention.

FIG. 2 is a flow chart showing an exemplary embodiment showing a system incorporating the Device Echo Cancellation Module according to the present invention.

FIG. 3 is an illustration of an application of the Voice Echo Cancellation Module according to the present invention.

### DETAILED DESCRIPTION OF THE PREFERRED EMBODIMENT(S)

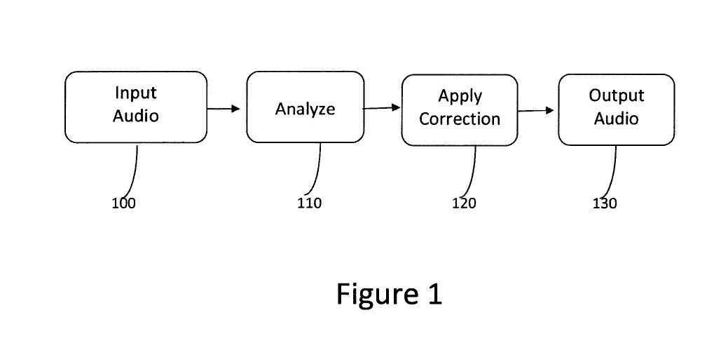

An embodiment of the echo cancellation device of the present invention is described and shown in the flow chart of FIG. 1. Preferably, the inventive DEC process is performed by a single module as shown in the flow chart of FIG. 1. Input audio 101 can be any audio source such as audio received through a microphone, phone, TV, CD and the like.

Input audio 100 is fed to an analog to digital convertor (not shown) where the amplitude of the sound wave is sampled at regular intervals and translated into digital PCM audio suitable for transmission. The Analyze step 110 performs an evaluation and analysis of the PCM audio for its dynamic and harmonic content. In particular, in this step PCM audio is analyzed for repetitive harmonic content and the first repetitive harmonics are analyzed and differences in their amplitudes are determined.

This determination, in turns, provides a scale for the identification of the subsequent harmonics as one skilled in the art would appreciate that the subsequent harmonics will also be distributed according to the same determined scale. The determined scale will then act as the basis for the dynamic reduction amounts that are to be identified in the subsequent repeats.

These reductions are used to calculate and create corrective waves new harmonic content with descending amplitude levels according to the determined scale. These newly created sound waves are in turn applied 120 to the original repeating audio waves (echoes) in varying phase shift of 180 to 90 degrees, depending on the amplitude of the echoes, in a negative direction. The resulting combination of the original sound waves and the newly created audio sounds, which will result in a cancellation of the repetitions present in the original audio sound, is outputted 130.

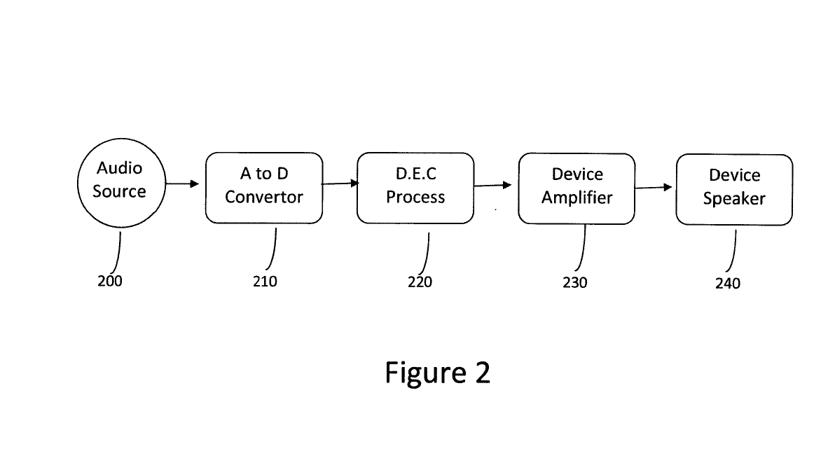

FIG. 2 is a flow chart showing a high-level operation and function of the inventive D.E.C. module according to an embodiment of the present invention. Accordingly, in the first step, 200, audio signal is provided and fed to an analog to digital convertor 210 in the device, where the received signal is converted to a digital signal.

The converted digital signal is then fed to the inventive D.E.C. module 220, which analyzes the audio and immediately starts searching for repetitive harmonic content. As the D.E.C. process is applied to the repetitive harmonics as described above, it results in the lessening of harmonic content in any repetitive harmonics (echoes) and adjust itself accordingly.

As explained above, upon identification of the repetitive harmonics, there will be a comparison of this new repeat of the harmonic for amplitude and the process will change the phase of the harmonic by 90 to 180 degrees, while lessening the amplitude by the difference in each repeat. The reduction of each repeat sound wave will be dynamic. The D.E.C. processed audio then passes through the device audio path 230 to the device speaker, 240, where listener can hear it.

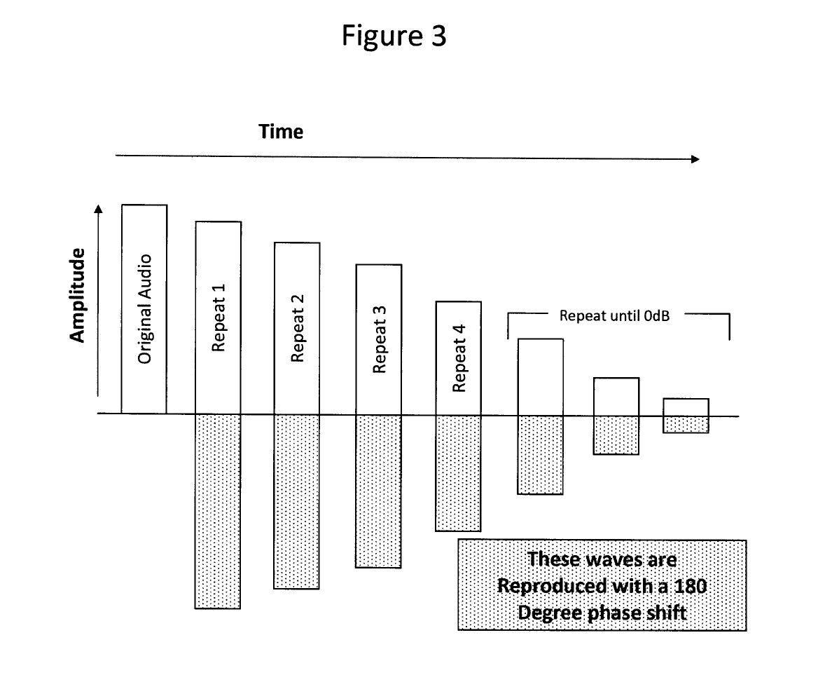

FIG. 3 depicts a diagram that shows an example of acoustic repeats (echoes) that are successively reduced in amplitude until no longer present. As explained above, the inventive D.E.C. process measures each of these repeat sound waves with the smaller amplitudes and digitally reproduces the same waveform in a 90 to 180 degree phase shifted version with the amplitude of every repeat matching the source repeat. The reproduced waveform is then added back to its corresponding echo, resulting in a dynamic cancellation of the echoes.

What is claimed is:

1. An Echo Cancellation Device comprising:
Providing an input audio source;
Converting the input audio source to a digital signal via a PCM convertor where the amplitude of the input audio source is sampled at regular intervals and translated into digital PCM audio;
Analyzing the PCM audio for dynamic and harmonic content;
Generating corrective sound waves that reduce the repetition of the original audio (echoes);
Applying the corrective sound waves to the repeating audio echoes to create corrected sound waves;
Outputting the corrected audio with diminished echoes.

2. The Device Echo Cancellation process of claim 1, wherein the analyzing step comprises:
Performing an evaluation of the PCM audio for dynamic and harmonic content;
Identifying repetitive harmonic content (echoes) of the PCM audio;
Determining a scale based on the ratio of the amplitude of the first repeat harmonic to the amplitude of the input PCM audio;
Generating sound waves with descending amplitude levels according to the determined scale; and
Phase shifting the newly generated sound waves to generate corrective sound waves.

3. The Device Echo Cancellation process of claim 2 wherein the phase shift is between 90 and 180 degrees.

4. The Device Echo Cancellation process of claim 1 wherein the corrected audio is substantially free or repeating audio waves (echoes).
